(19) United States
(12) Patent Application Publication
(10) Pub. No.: US 2004/0039609 A1
(43) Pub. Date: Feb. 26, 2004

(54) System and method for payment of insurance premiums for vessels

(76) Inventor: Sarah Burkitt, Eden Prairie, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/226,014

(22) Filed: Aug. 22, 2002

(51) Int. Cl. G06F 17/60

(52) U.S. Cl. 705/4

(57) ABSTRACT

The system and method for payment of insurance premiums for vessels generally involves the use of a global positioning system receiver integral to a vessel and a transmitter which communicates the GPS coordinates of the vessel to an insurance company. A processor at the insurance company verifies the received GPS coordinates and compares the received GPS coordinates to a database catagorizing insurance premiums based upon geographic premium zones. In the event that a premium adjustment is mandated based upon the location of the vessel then a controller at the insurance company initiates an automatic premium adjustment through an electronic funds transfer withdrawal from a customer account to provide continuous insurance coverage for the vessel during a voyage.

### BACKGROUND OF THE INVENTION

Calculation of insurance premiums for vessels and especially sailing vessels in the past has been problematic. Insurance rates for vessels is, in a large part, dependent upon the geographic location of the vessel and the bodies of water to be sailed upon. In addition, insurance premiums are based upon the experience of the sailor/captain, the age and type of vessel, as well as the cost and time of year for the voyage for actuarial calculation of the risks exposed to a vessel due to weather conditions or otherwise.

Insurance premiums for vessels frequently vary and/or change between geographic locations and/or zones to reflect variations and risk of loss. For example, insurance premiums differ between a vessel traversing the middle of a large body of water such as the Pacific Ocean as compared to day sailing within Puget Sound. In fact, the insurance premiums for day sailors may be proportionally larger than the premiums assessed for professional Merchant Marine captains.

In the past, sailors have desired to modify and/or alter the destination of a vessel during a voyage. Prior to departure on a voyage a sailor generally has been required to contact an insurance company to advise the insurance company of the planned voyage for payment of an adjusted insurance premium based upon the planned voyage. Continuous coverage for a vessel was thereby provided. A failure to contact a marine insurer and pay for an adjusted premium frequently resulted in gaps in coverage where a loss claim may have been partially or fully denied by an insurance company. In the past, sailors sacrificed spontaneity in voyages in order to maintain continuous insurance coverage.

In the past, real time calculation and payment of insurance premiums for vessels and particularly sailing vessels has not been available to provide a sailor with spontaneity in the selection of alternative destinations for a voyage. A need therefore exists for such a real time calculation and payment system for adjusted insurance premiums for a vessel.

### BRIEF SUMMARY OF THE INVENTION

The system and method for payment of insurance premiums for vessels generally involves the use of a global positioning system receiver proximate or integral to a vessel and a transmitter which communicates the GPS coordinates of the vessel to an insurance company. A processor at the insurance company verifies the received GPS coordinates and compares the received GPS coordinates to a database catagorizing insurance premiums based upon geographic premium zones. In the event that a premium adjustment is mandated based upon the location of the vessel, then a controller at the insurance company initiates an automatic premium adjustment through an electronic funds transfer from a customer account to provide continuous insurance coverage for the vessel during a voyage.

It is a principal advantage of the present invention to provide a system and method for calculation and payment of insurance premiums which is simple and cost effective to implement and which facilitates the real time adjustment of insurance premiums to provide continuous coverage for a vessel while simultaneously providing sailors with spontaneity in the selection of voyage destinations and sailing routes to reach the desired destinations.

It is another principal advantage of the present invention to utilize existing global positioning system (GPS) technology for identification of the location of a vessel.

It is still another principal advantage of the present invention to utilize existing communication equipment and procedures including, but not necessarily limited to, radio, telephone, and/or the global telecommunications network to transmit the location of a vessel as identified by a GPS receiver to an insurance company for real time calculation of an adjusted insurance premium for the vessel.

It is still another principal advantage of the present invention to utilize existing technology including the use of identified accounts and access restrictions such as passwords for the real time electronic funds transfer for payment of an adjusted insurance premium for a vessel.

It is still another principal advantage of the present invention to provide a system to adjust an insurance premium for a vessel and/or a vehicle such as an airplane, automobile, and/or truck.

It is still another principal advantage of the present invention to provide a confidential tracking record for a vessel so that a vessel may be warned of emergency conditions.

It is still another principal advantage of the present invention to utilize a controller which at regular intervals initiates receipt of GPS coordinates from one or more GPS satellites for up-loading and/or down-loading to an insurance carrier computer for calculation of an adjusted insurance premium.

It is still another principal advantage of the present invention for an insurance company to utilize a computer having data storage representative of maritime zones, and calculation software which in real time may process an adjusted insurance premium for a vessel.

It is still another principal advantage of the present invention for an insurance company to utilize a computer having prestored vessel and personal information including, but not necessarily limited to, vessel type, vessel age, vessel cost, vessel condition, individuals name and personal information, sailing experience, account information, and/or any other passwords to access preexisting accounts for real time electronic transfers of funds for payment of an adjusted insurance premium.

### BRIEF DESCRIPTION OF THE SEVERAL VIEWS OF THE DRAWING(S)

FIG. 1 shows a schematic representation of the communication of GPS coordinates to an insurance company.

FIG. 2 shows a block diagram of a method to practice the invention.

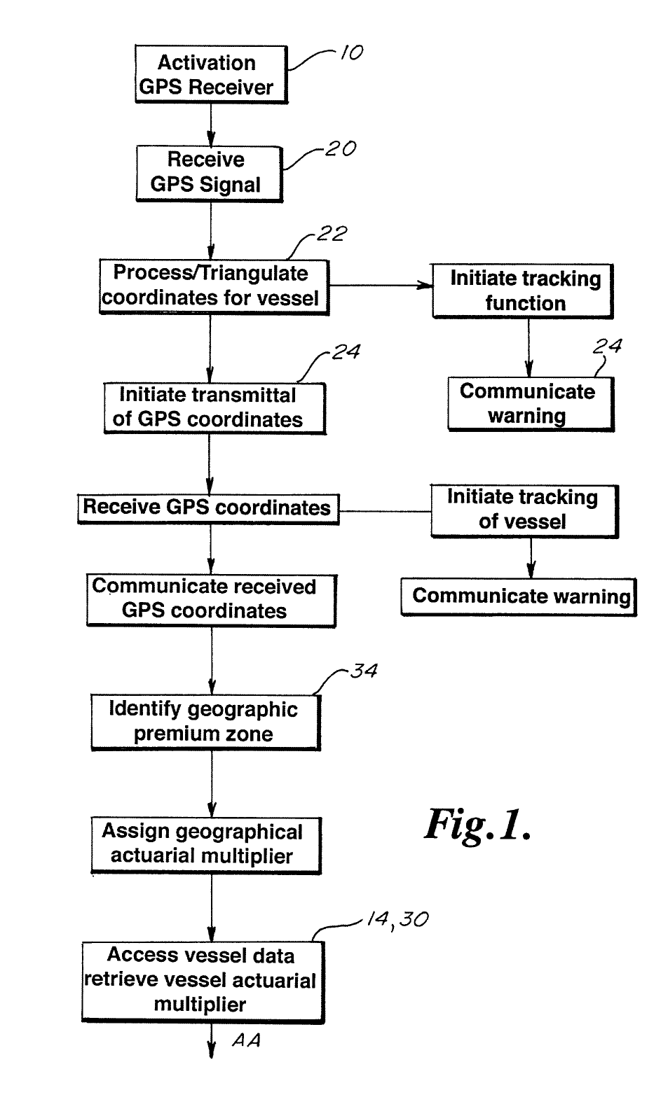

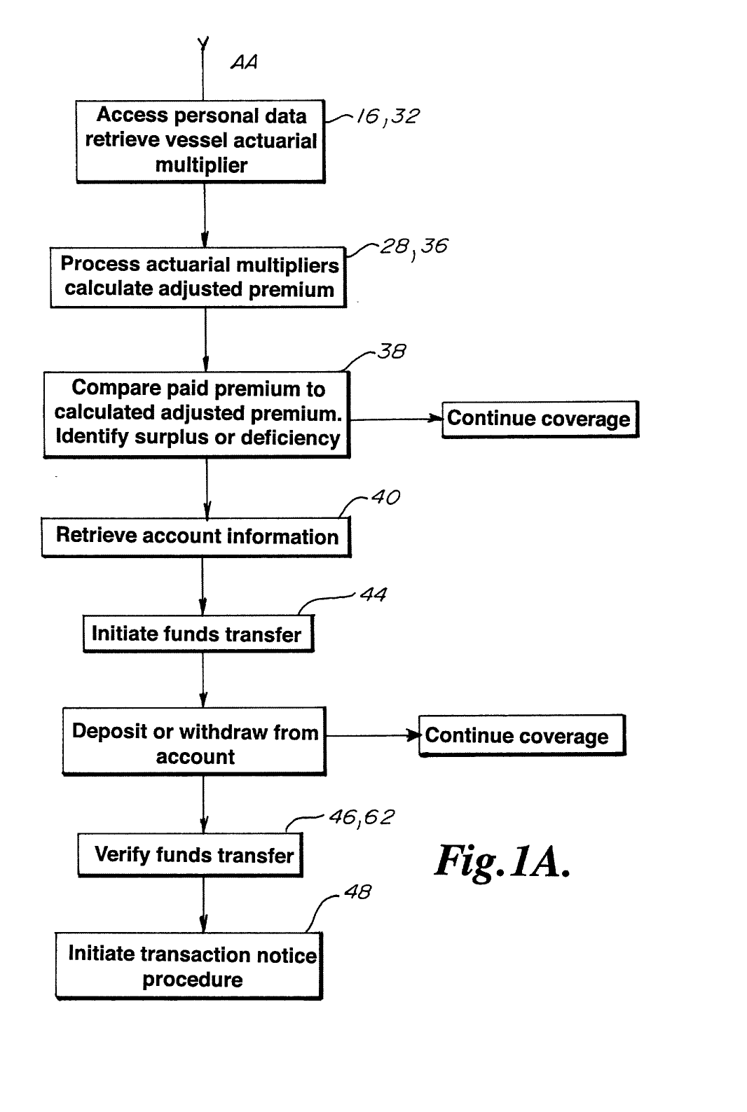

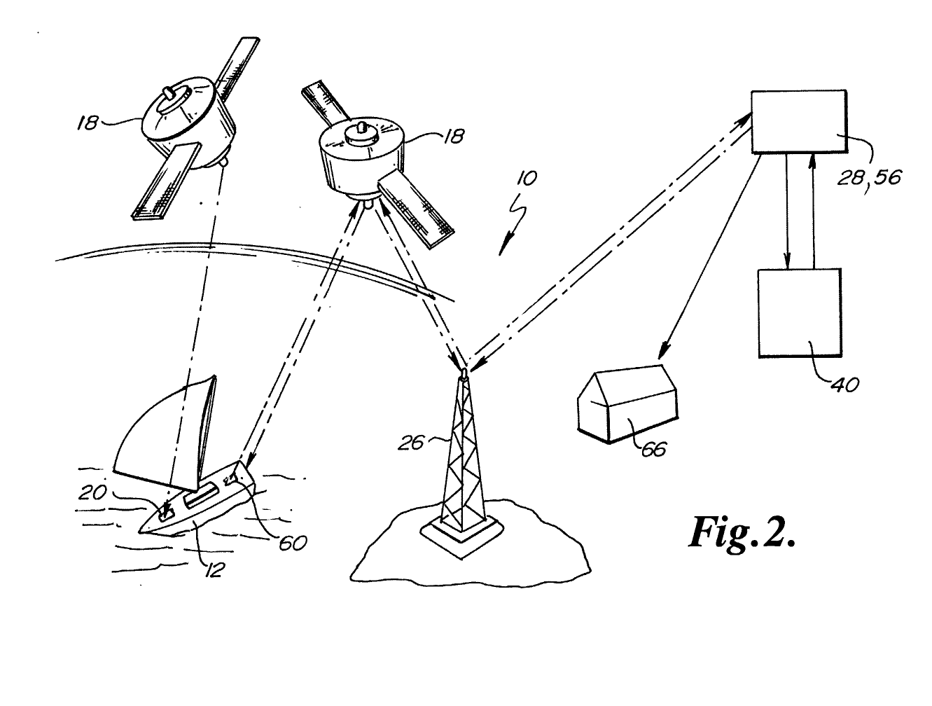

### DETAILED DESCRIPTION OF THE INVENTION

In general, the system and method for payment of insurance premiums for a vessel is generally referred to by the numeral 10. The system and method for payment of insurance premiums for a vessel generally includes the components of a vessel 12, a global positioning satellite system 18, an onboard global positioning system receiver 20, an onboard computer 22 in communication with the GPS receiver 20, and onboard telecommunication equipment 24 in communication with the computer 22 and GPS receiver 20. In addition, the system and method for payment of insurance premiums for vessels 10 includes the use of an insurance company computer 28 having storage data related to a vessel 30, storage data related to personal information 32, geographic maritime zones 34, insurance premium calculation software 36, insurance premium comparison software 38, and electronic funds transfer systems and equipment 44. The insurance company computer 28 preferably uses actuarial data to assign multipliers and/or factors for the calculation of an adjusted insurance premium to be charged to an individual/vessel during transition between different maritime zones. Telecommunications equipment is utilized to access accounts and passwords for the electronic funds transfer in real time for payment of an adjusted insurance premium, in order to simultaneously maintain coverage for a vessel during a voyage. Gaps in insurance coverage for a vessel during a voyage are thereby eliminated.

Vessel information 14 may include information as to whether or not the vessel is a sailing vessel or whether the vessel includes a propulsion system. Vessel information 14 may further include whether the vessel is a boat, automobile, truck, airplane, and the type, size, age, cost, replacement value, condition of the hull, and/or status of repair for the vessel. Vessel information 14 may additionally include information such as the elected insurance liability limits as well as any insurance deductible. Further, the vessel information 14 may include information related to the current licensing status of the vessel and the types and condition of electrical communication systems, backup systems, global positioning systems, and/or computer. In addition, vessel information 14 may also include information related to the nature and condition of emergency equipment and historical information related to previous insurance claims and/or losses, port of registration, and most likely areas for sailing/passage. The above-identified information as well as other vessel/vehicle related information may be considered in determining an actuarial multiplier and/or algorithm related to the vessel for calculation of an insurance premium.

In general, information related to the individual insured 32 would include items such as the name, address, age, health, experience, professional versus day sailor, education, licensing classification, and/or training for an individual. In addition, the personal information 32 may include information related to the geographic locations most frequently traveled, and historic data related to previous voyages and/or past claims or incidents. From the personal information 32 an insurance company may generate a composite individual insurance profile which may be utilized to determine an individual actuarial multiplier and/or algorithm which is utilized with other actuarial multipliers for calculation of an insurance premium for a vessel within a particular geographic and/or maritime zone.

The global positioning system (GPS) is a space based triangulation system that uses satellites 18 and computers 22 to measure the position in degrees longitude and latitude for a vessel upon the surface of a body of water or other location. Generally, three GPS satellites 18 are utilized in conjunction with GPS software to indicate the relative position of the vessel 12 upon a body of water or other location. When activated, the GPS software provides the position of the GPS receiver 20 as mounted on, or within, a vessel 12.

The onboard computer 22 may also include triangulation software to process one, two, or three or more GPS signals to calculate and/or triangulate the position of a vessel relative to a body of water.

The GPS receiver 20 may be implemented in a variety of applications which may include a data collector and/or self-tracking memory. When utilized as a data collector, the GPS receiver 20 may record received GPS information for the vessel 12. Each position recorded of the GPS receiver 20 may then be logged with a date and time indicator within the storage device. At regular intervals the recorded GPS information may be downloaded to an onboard computer 22 which in turn may be transmitted to an insurance company computer 28 via the use of onboard telecommunication equipment 24. The GPS receiver 20 may be utilized as a self-tracking unit where the GPS receiver 20 is connected to the onboard computer 22 as located within a vessel 12. GPS information may be communicated from the GPS receiver 20 to the onboard computer 22 via the use of a communication link. The communication link is also preferably mounted or located within a vessel. In this embodiment, the onboard computer 22 receivers, records, processes, and may display the longitude and latitude coordinates as received from the GPS satellite system.

A vessel 12 may additionally include one or more redundant backup GPS receivers 20. Alternatively, a vessel 12 may include non-electronic positioning devices such as a sextant to calculate the longitude and latitude coordinates of a vessel manually for entry into an onboard computer 22. The onboard computer 22 also preferably includes an accurate time and date clock for use by a sailor to calculate longitude and latitude coordinates through the use of traditional navigation instruments.

Preferably the GPS receiver 20 includes a timer to regularly and periodically communicate with the GPS satellites 18 for positioning of a vessel 12 relative to a body of water or other geographic location. The GPS receiver 20 may include an onboard diagnostic interface to relay GPS data via either the global telecommunications network, cellular phones, and/or radios which may comprise the onboard telecommunications equipment 24. Antenna are preferably connected to the GPS receiver 20 to facilitate receipt of signals from the GPS satellites 18. A vessel navigator may utilize the GPS data for reference to electronically stored maps or standard maps to identify the relative location of the vessel 12 at a specific date and time.

Further, the GPS data as received by the GPS receiver 20 may be entered and stored within a waterproof and/or pressure proof electronic storage unit which may be integral to an emergency locator device such as an emergency beacon. In addition, an onboard computer 22 may be in communication with a data storage device or emergency warning recorder 54 integral to a waterproof emergency flotation and homing device such as an emergency buoy. In the event of a maritime catastrophe an emergency buoy may be retrieved where GPS tracking information has been previously recorded. Emergency personnel may extrapolate the relative position of the maritime catastrophe based upon the recorded date and time entries, position of the last GPS entry, and the tidal conditions of the body of water between the last entry and retrieval of the buoy to facilitate rescue of survivors.

The onboard computer 22 generally includes interface software which is utilized to communicate with the GPS receiver 20. The onboard computer 22 is further coupled to the telecommunication equipment 24 to rely information and/or messages to an insurance company receiver 60. The insurance company receiver 60 in turn is in communication with the insurance company computer 28 for processing information and/or messages received from the telecommunication equipment 24.

The onboard computer 22 processes various types of messages and/or information including, but not necessarily limited to, longitudinal and latitudinal coordinates as received from the GPS receiver 20, weather information, emergency messages, and/or other types of signals communicated in either a digital and/or analog format.

The onboard computer 22 preferably includes sufficient memory for storage and access of recognition protocol and/or passwords to verify the identity of a vessel 12 during transmission of information to an insurance company receiver 60 and/or insurance computer 28. The recognition protocol may include identification signals which may be in the form of a bar code and/or any other preselected random combination of letters and/or numbers. In addition, one or more passwords may be utilized within a recognition protocol. For example, each voyage may be assigned an individualized identification or bar code number to be transmitted with an initial recognition protocol including a first authentic password. In addition, a second password may be authorized which triggers the communication of the existence of an emergency situation for receipt by the insurance company computer 28. In this manner a sailor may simultaneously signal the existence of an emergency situation through use of the onboard telecommunication equipment 24 and/or the onboard computer 22.

The onboard computer 22 may also be linked to various communication devices such as a modem, fax machine, onboard telecommunication equipment 24, screen monitors, and/or printers for communication of information to an individual. The onboard computer 22 may also include one or more timing mechanisms which are programmed to generate a signal or activate a switch to engage the GPS receiver 20 for receipt of a GPS signal from the GPS satellites 18.

The computer 22 may further trigger the engagement of the telecommunication equipment 24 at regular time intervals for transmission of information to an insurance company computer 28.

The onboard computer 22 is also programmed to indicate an error or fault condition upon the failure to receive information from the GPS receiver 20 at any preselected time interval. In this situation the onboard computer 22 may transmit either a verbal and/or audible error message to an individual or may activate a switch to engage a redundant backup system to communicate with the GPS receiver 20 and/or to activate a second GPS receiver for identification of longitude and latitude coordinates from GPS satellites.

The onboard computer 22 may include testing diagnostics to verify the operational status of the GPS receiver 20, the onboard telecommunication equipment 24, and/or any other emergency signaling system. The onboard computer 22 also may include industry standard communication interfaces for communication through the mediums of radio, cellular telephone, and/or the global telecommunications network as well as other forms of communication systems commonly used in association with vessels. The onboard computer 22 may also be programmed to activate the telecommunication equipment 24 to generate an emergency message and/or signal to a rescue authority such as the Coast Guard and/or an insurance company.

The onboard computer 22 is preferably programmed to verify data received from the GPS receiver 20 to insure that the information received from the GPS receiver is accurate and has not been erroneously processed. As such, the onboard computer 22 preferably includes one or more microcontrollers or microprocessors associated with the computer memory. The calculation software as integral to the onboard computer 22 preferably receives information from the GPS receiver 20 for processing data to verify the accuracy of the longitude and latitude coordinates received from the GPS satellite 18. The computer may automatically initiate a comparison to previously recorded longitude and latitude coordinates received from the GPS satellite 18 to track a vessel during a voyage. In addition, the onboard computer 22 may be programmed to automatically calculate longitude and latitude coordinates, vessel identification, and the geographic position of the vessel on a body of water, at regular and periodic time intervals to coincide with periodic activation of the GPS receiver 20.

The onboard computer 22 preferably includes stored data concerning differing marine zones or geographic zones, estimated insurance premiums, maps, and/or other information for navigation and to calculate estimated insurance premium adjustments for review by individuals.

The telecommunications equipment 24 is generally formed of traditional types of equipment such as short and long range radio, digital radio, cellular phones, digital cellular phones, wireless networks, global telecommunications networks, facsimile transmissions or other wireless communication devices including but not necessarily limited to backup and/or redundant systems. These types of telecommunications equipment 24 in conjunction with other sophisticated devices such as radar and/or global positioning systems are commonly used within marine vessels. The onboard computer 20 generally triggers the initiation of the telecommunication equipment 24 for generation of a signal to either a base station, emergency authority, and/or insurance company receiver as integral to an insurance company computer 28. Messages and/or signals may be relayed from a vessel to an insurance company computer 28 through cable, satellite, wireless communications systems, the worldwide telecommunications network, and/or antenna or through communication towers as are known. Other types of message transmittal equipment are also contemplated and the disclosed equipment herein is not restricted to the types of communications systems identified. It should be noted that the wireless network generally is only required upon bodies of water, as other communication equipment is available once a signal reaches land, whereupon standard communication equipment may be utilized for transmittal of signals to the insurance company computer 28.

The telecommunication equipment 24 may transmit signals representative of recognition protocols, vessel identification information, personal identification information, longitude and latitude coordinates, the change of maritime and/or geographic zones for the vessel, weather information, and/or emergency messages or warning signals or other types of commonly used signals.

The telecommunication equipment 24 in conjunction with the onboard computer 22 may record any and/or all global positioning system readings as generated by the GPS receiver 20. The computer 22 may simultaneously store recorded data within an emergency beacon such as a waterproof or pressure proof buoy through a communication link. The emergency buoy may therefore assist in the positioning of a submerged vessel due to the retrieval of the emergency buoy and the calculation of the last known coordinates for the vessel as based upon the location of the buoy as retrieved in view of the known time lapse and water currents. A search and rescue operation may therefore be narrowed to maximize likelihood of the retrieval of survivors from a maritime disaster.

The insurance company computer 28 generally includes memory an/or E-Prom memory for storage of information and data as related to vessel information 30, personal information 32, geographic premium zones 34, account information 40, as well as vessel tracking data 50.

Different maritime zones 34 may each include a different actuarial multiplier when evaluated in conjunction with vessel data, personal data, and the current date and time data for calculation of an adjusted premium if necessary. For example, Cape Horn, South Africa, may have a relatively high actuarial multiplier as compared to the Atlantic Ocean adjacent to North and South Carolina in the month of April. In addition, the actuarial multiplier for the geographic zone for the Atlantic Ocean adjacent to North and South Carolina may be increased during hurricane season between June and November of a given calendar hear.

Information related to an insurance policy and/or account 40 will also be stored within an insurance company computer 28 memory. Policy and/or account information may include data such as previous insurance premiums and amounts paid, account numbers, policy numbers, financial institutions, contact information for financial institutions, and access protocol and/or passwords to access identified accounts. The account data 40 will be accessed by the insurance company computer 28 when a global positioning system signal has been recorded and the premium calculation software 36, upon evaluation of the actuarial multipliers related to geographic zone, vessel data, and personal data, indicate that an insurance premium is required to be adjusted in real time to secure continuous insurance coverage for a vessel during a voyage.

The insurance premium calculation software 36 generally provides a value for the amount of the insurance premium which is due. Premium comparison software 38 then compares the insurance premium paid to the premium due to identify a surplus and/or deficiency for an insurance premium. The comparison software 38 then triggers the electronic funds transfer software 62 to either make a deposit into, or a withdrawal from, a vessel account 40. The insurance premium calculation software 36 preferably compares the actual premium paid to the adjusted premium due based upon the actuarial factors identified herein. In the event that overpayment has been made a credit process may be initiated for insertion into an individual insured's account the amount of surplus premium as previously paid. Alternatively, the insurance comparison software 38 may indicate that additional adjusted insurance premium funds are due to secure continuous coverage during a voyage. In this instance, electronic funds transfer equipment 46 and software 62 may be initiated to electronically withdraw a required premium adjustment to secure continuous coverage for the vessel. The electronic funds transfer software 62 is required to interface with the access data 42 for the vessel to retrieve appropriate access passwords for an insured vessel account 40. Transaction verification software 46 may then be engaged to examine and verify that the correct type and amount of electronic funds transfer has actually occurred, whereupon, the transaction notice software 48 may be engaged to notify an insured/vessel 66 of an electronic funds transfer from a vessel account 40.

The insurance company computer 28 provides further benefits related to flexibility to provide a tracking function for a vessel in the event of an emergency. For example, in the event that a vessel has been lost and an emergency search for survivors is implemented, then the insurance company computer 28, recording the global positioning system coordinates, may serve a tracking function to provide the last known longitude and latitude coordinates for the vessel as well as the date and time of the most recent positioning of the vessel prior to the emergency situation. Emergency rescue personnel may then be able to narrow a search area based upon estimated time of drift and sea and/or weather conditions improving the probability of recovery/rescue of survivors.

Further, the insurance company computer 28 and insurance company transmitter 58 may be used to warn a vessel 12 of dangerous conditions such as the existence of a typhoon or a hurricane. In this instance, the insurance company computer 28 may be in communication with a source of information such as weather data. The insurance company computer 28 may then search and identify a zone of longitude and latitude coordinates which may be affected by the dangerous weather condition. The insurance company computer 28 may then implement a search of recorded longitude and latitude coordinates for vessels 12 to identify vessels 12 which are likely to be affected by the weather condition. The insurance company computer 28 may then issue a weather warning or advisory signal for receipt by the vessel receiver 60 as part of the onboard telecommunications equipment 24. In this manner an insurance company computer 28 is implementing a proactive procedure to minimize risk of loss of life and property while simultaneously minimizing the likelihood of claims and payments of claims due to an insured loss. Further, the insurance company computer 28 enables an insurance company to adjust an insurance premium for a vessel in real time to provide continuous insurance coverage for the vessel during the voyage.

An insured vessel 12 may implement any desired procedures to pay for an adjusted premium during a voyage including, but not necessarily limited to, a direct withdrawal from a previously established deposit account at the insurance company or a savings and/or checking account, a direct debit from an existing savings and/or checking account at a financial institution, or a direct charge to a credit account or line of credit. It is anticipated that payment of an adjusted premium shall occur through the direct debit and/or withdrawal from a deposit account within the insurance company. Alternatively, it is anticipated that the payment of an adjusted premium shall occur through the direct withdrawal and/or debit from an account such as a checking or savings account by direct electronic funds transfer software from an independent financial institution.

The definition of vessel may also be broad enough to include other vehicles such as boats, airplanes, automobiles, trucks, taxis, and/or any other type of commercial transport vehicles and/or carriers such as trains. The definition of vessel herein is not intended to be limited but is intended to be sufficiently broad to encompass any type of vessel or vehicle which is readily positionable through the use of global positioning systems for tracking of the vessel/vehicle.

Insurance company computer 28 may also be programmed to be proactive to search for an expected global positioning system signal as transmitted from a vessel 12 on a regular time schedule. The non-receipt of a regularly scheduled signal may then trigger the insurance company to issue a mayday or emergency warning signal to rescue personnel to implement operations to investigate a potential loss. It is anticipated that a vessel will have sufficient redundant equipment where contact and/or communication with an insurance company will occur to minimize and/or to eliminate the risk of a false emergency warning signal, and the initiation of unnecessary search and rescue operations upon the malfunction of onboard communication equipment. In this regard, the onboard computer 20 preferably has software which regularly and periodically tests the operational status of onboard equipment including, but not necessarily limited to, the telecommunication equipment to automatically switch to a redundant system in the event of detection of a fault, failure, and/or non-operational status for the equipment evaluated.

The methodology for the payment of an adjusted insurance premium for a vessel 12 during a voyage initiates upon the activation of a global positioning system (GPS) receiver 20 which is proximate and/or integral to a vessel 12. The GPS receiver 20 will then receive a GPS signal from three of the global positioning system satellites 18 for triangulation of the longitude and latitude coordinates for the vessel 12. An onboard computer 22 receives the GPS signal representative of longitude and latitude coordinates and initiates the onboard telecommunication equipment 24 whereupon the GPS signal is transmitted to an insurance company computer 28 through satellite communication and/or radio towers 26. The insurance company receiver 56 will communicate the GPS coordinates of the vessel 12 into the insurance company computer 28.

Upon receipt of the GPS coordinates at the insurance company computer 28, a search will be implemented by the insurance company computer 28 to identify a particular premium zone for the location of the vessel 12. Different premium zones may have differing actuarial multipliers based upon associated risk within a relative geographic area. The insurance company computer 28, will then assign the geographic zone actuarial multiplier representative of the coordinates identified from the GPS positioning system. Next, the insurance company computer 28 will access previously stored vessel data 30 for identification of a previously identified vessel actuarial multiplier. Next, the insurance company computer 28 will access previously stored personal data representative of a personal actuarial multiplier representative of the policy owner. The insurance company computer 28 may then access and retrieve any further actuarial multipliers as may be desired related to the likelihood of undesirable seasonal weather conditions or other known actuarial multipliers associated with known risks.

The premium calculation software 36 integral to the insurance computer 28 will then calculate an adjusted insurance premium which is due upon processing of the insurance premium zone actuarial multiplier, the vessel actuarial multiplier, the personal actuarial multiplier, and/or any environmental or other actuarial multiplier which may be appropriate.

Comparison software 38 is then implemented within the insurance company computer 28 to compare a previously paid insurance premium as related to the calculated adjusted insurance premium to determine whether or not a surplus premium has been paid or whether a deficiency exists related to the adjusted insurance premium. In the event that a deficiency is identified related to the adjusted insurance premium then the insurance company computer 28 may retrieve and access account data 40 for a vessel. The insurance company computer 28, may then identify account access data 42 which has been previously stored for initiation of electronic funds transfer equipment 44 to withdraw any deficiency amount from a pre-established deposit account. Alternatively, the electronic funds transfer equipment 44 having any access data 42 may be implemented to debit a checking or savings account, and/or credit line or credit card. Continuous insurance coverage may thereby be provided for a vessel 12 during a voyage regardless as to the location of the vessel 12 relative to separate geographic zones representative of geographic actuarial multipliers.

The access data 42 as retrieved by the insurance company computer 28 may include information such as account number, financial institution, and/or desired security protocols such as passwords.

The data representative of the vessel 30 may additionally include a first protocol password and a second protocol password. The first protocol password may be the standard password to identify a normal operational status for a vessel 12. A second protocol password may trigger a prestored warning signal within the insurance company computer 28 to advise the insurance company as to the existence of an emergency situation.

The insurance company computer 28 may further implement a transaction verification procedure 46 to verify the electronic transfer of funds sufficient to pay any deficiency between a previously paid insurance premium and the amount due for the adjusted insurance premium. Upon the completion of the electronic funds transfer system, the insurance company computer 28 may further initiate the provision of a transaction notice 48 to a customer. The transaction notice may be selected from the group consisting of mail, express mail, facsimile, and/or e-mail messages as mailed to a customer.

The insurance company computer 28 may further store previously received GPS coordinates for a vessel in order to implement a tracking function for the vessel during a voyage. An insurance company may therefore be able to assist in the narrowing of a search zone to maximize safety to individuals while simultaneously minimize risk of an insured loss.

A vessel 12 may further include emergency warning transmitters and receivers 52 and 54 while the insurance company may simultaneously utilize insurance company emergency receivers 56 and 58 to assist in the maximization of safety to individuals and/or the minimization of risk of loss.

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

1. A method for payment of an adjusted insurance premium for a vessel comprising:
a) activating a global positioning system receiver which is proximate to the vessel;
b) receiving positioning coordinates from a global positioning system;
c) initiating transmittal of received global positioning system positioning coordinates to a receiver in communication with an insurance company;
d) processing the received global positioning system coordinates for calculation of an adjusted insurance premium; and
e) accessing an account for electronic funds transfer in response to the adjusted insurance premium.

2. The method according to claim 1 wherein said global positioning system receiver is integral to said vessel.

3. The method according to claim 1 further comprising communicating said received positioning coordinates to an onboard computer.

4. The method according to claim 3 wherein said onboard computer initiates transmittal of the received positioning coordinates.

5. The method according to claim 4 further comprising communicating positioning coordinates to an insurance company computer.

6. The method according to claim 5 further comprising comparing said positioning coordinates to data representative of geographic zones stored in said insurance company computer.

7. The method according to claim 6 further comprising assigning a geographical actuarial multiplier representative of said geographic zone data as stored in said insurance company computer.

8. The method according to claim 7 further comprising retrieving an actuarial vessel multiplier from said insurance company computer.

9. The method according to claim 8 further comprising retrieving an actuarial personal multiplier from said insurance company computer.

10. The method according to claim 9 further comprising calculating said adjusted insurance premium from said geographical actuarial multiplier, said vessel actuarial multiplier, and said personal actuarial multiplier.

11. The method according to claim 10 further comprising comparing said adjusted insurance premium to a paid insurance premium to identify an insurance premium discrepancy.

12. The method according to claim 11 further comprising retrieval from memory account access information to enable initiation of said electronic funds transfer.

13. The method according to claim 12 wherein said account access information includes passwords.

14. The method according to claim 11, said electronic funds transfer comprising deposit into said account wherein said deposit represents the excess between the insurance premium paid and the adjusted premium.

15. The method according to claim 11 said electronic funds transfer comprising withdrawal from said account where said withdrawal represents the deficiency between the insurance premium paid and the adjusted insurance premium.

16. The method according to claim 11 wherein said account is a deposit account.

17. The method according to claim 11 wherein said account is a checking account.

18. The method according to claim 11 wherein said account is a credit line.

19. The method according to claim 1 further comprising verifying transactional information and electronic funds transfer.

20. The method according to claim 19 further comprising issuing a transaction notice to a customer.

21. The method according to claim 1 further comprising storing of received global positioning service coordinates for tracking of a vessel.

22. The method according to claim 5 wherein said storing occurs at said onboard computer.

23. The method according to claim 5 wherein said storing occurs at said insurance company computer.
